(19) United States
(12) Patent Application Publication
(10) Pub. No.: US 2008/0000116 A1
(43) Pub. Date: Jan. 3, 2008

(54) Photo/greeting card memento basket kit

(76) Inventor: Sharon Linda Last, Great Neck, NY (US)

Correspondence Address: Sharon Linda Last, 122 Pine Hill Road, Great Neck, NY, 11020, US

(21) Appl. No.: 11/820,412

(22) Filed: Jun. 19, 2007

Related U.S. Application Data
(60) Provisional application No. 60/817,653, filed on Jun. 30, 2006.

(51) Int. Cl. G09F 1/00

(52) U.S. Cl. 40/124.01

(57) ABSTRACT

A kit that includes patterns and instructions for making baskets out of photos and/or greeting cards. Photos and/or greeting cards are cut according to said patterns and then stitched together to form a basket. The size and spacing of the stitching holes can be varied such that kits suitable for use by all ages and levels of skill are possible.

### 1. CROSS-REFERENCE TO RELATED APPLICATIONS

This application claims the benefit of U.S. Provisional Application No. 60/817,653, filed Jun. 30, 2006 which is herein incorporated by reference in its entirety.

### 2. FIELD OF INVENTION

The instant invention relates to a method and craft kit for making baskets out of greeting cards and/or photographs

### 3. BACKGROUND OF THE INVENTION

Making baskets out of greeting cards is a craft that has existed for many years. A design patent for a card-basket (U.S. Pat. No. 10,130) was granted to Peter Rosenbach in July 1877. However, Mr. Rosenbach intended to actually manufacture the patented card-baskets himself; he did not provide instructions and patterns in order that individuals would be able to create their own baskets. Over the years, baskets made out of greeting cards have been created on a limited basis as a type of folk art. However, instructions and patterns for making these baskets have not been commercially available. Moreover, using photographs in lieu of greeting cards to construct a basket is a totally new idea. In addition, providing base and side patterns in a choice of shapes, allowing for many variations in the final basket, is a new idea. Finally, providing for variations in the size and spacing of the stitching holes, allowing individuals of different skill levels to create a basket, is novel.

### 4. BRIEF SUMMARY OF THE INVENTION

The present invention provides a method and kit for making a basket out of greeting cards or photographs. Following the kit's instructions, a basket is created by first tracing a provided base pattern and side patterns onto cards and/or photographs, then cutting out the traced patterns and punching designated holes, and finally by stitching the resulting base pieces and side pieces together.

In one embodiment of the invention, the kit may comprise of solely the patterns and instructions.

In another embodiment of the invention, the kit may comprise of the patterns, instructions, a hole puncher, a glue stick, a wide-eyed needle and lacing material.

In another embodiment of the invention, the components of the kit are grouped in a display but are sold individually.

It is an object of the present invention to provide a craft whereby young and old alike can create a decorative finished product—a basket—without the necessity of extensive training or particular artistic skills.

It is another object of the present invention to provide a creative manner of using greeting cards one has received and of using photographs one has accumulated.

### 5. BRIEF DESCRIPTION OF THE DRAWINGS

The accompanying drawings further describe the invention:

FIG. 1 is a drawing of an octagonal base pattern with sewing holes indicated

FIG. 2 is a drawing of a side pattern with sewing holes indicated

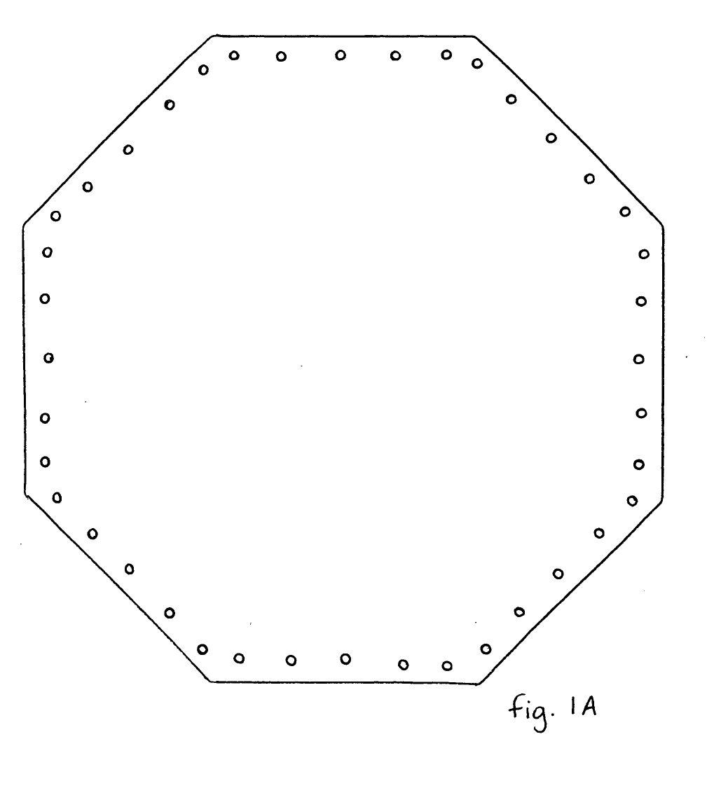

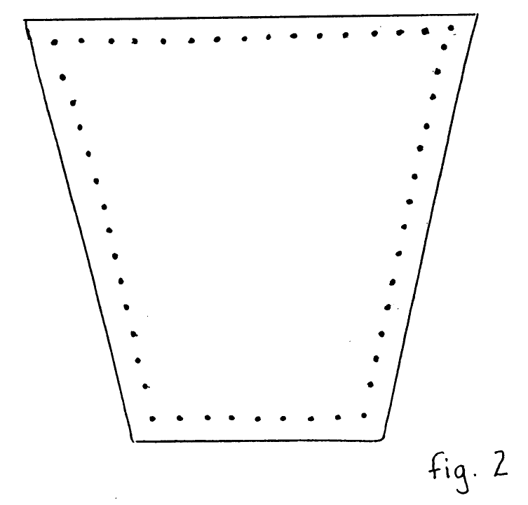

FIG. 1A is a drawing of an octagonal base pattern with larger, more spaced sewing holes

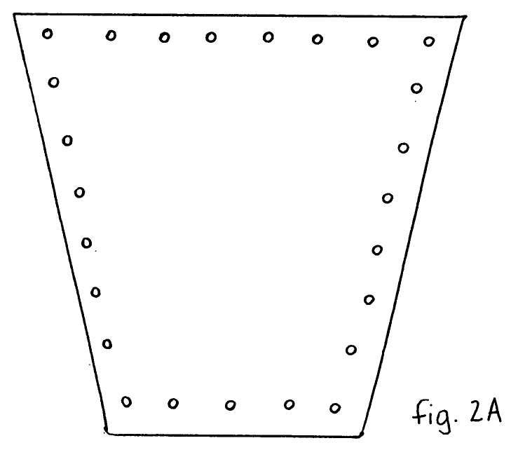

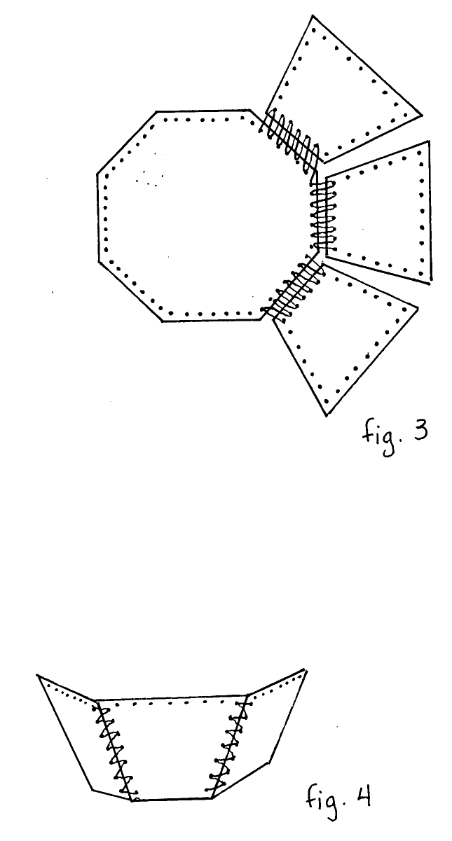

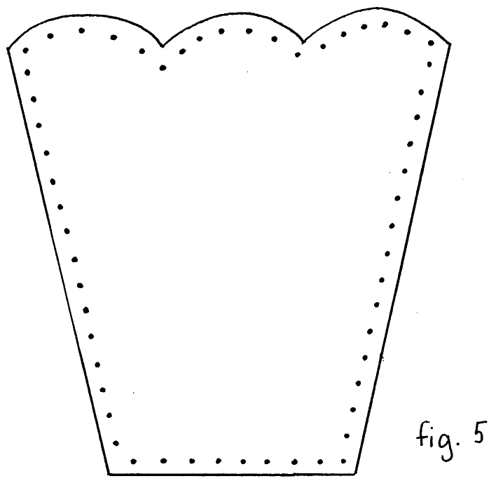

FIG. 2A is a drawing of a side pattern with larger, more spaced sewing holes

FIG. 3 illustrates how the sides of the basket are sewed onto the base

FIG. 4 illustrates how the sides of the basket are then stitched together

FIG. 5 illustrates one possible variation of the top of a side piece, a scalloped top

### DETAILED DESCRIPTION OF THE INVENTION

The invention, a photo/greeting card memento basket kit, provides instructions and traceable patterns for constructing a basket out of photos, greeting cards, or a combination of both. Preferred materials for the patterns are cardboard and plastic. A base pattern and a side pattern would be included in each kit. Said patterns may consist of one regular octagonal base (FIG. 1), and one side panel (FIG. 2) which is in the shape of an isosceles trapezoid with the smaller base equal in size to a side of the octagon. The octagonal pattern is traced onto 2 greeting cards or photos; the trapezoid-shaped side pattern is traced onto sixteen photos or cards. The traced figures are then cut out and small holes are punched around the perimeter of the pieces. (The patterns include information regarding the placement of these holes. Patterns with larger, more widely spaced holes [FIGS. 1A and 2A] make the project more manageable for younger or less adept crafters.) The two octagon pieces are then paired together, with the decorative sides facing outward; this results in one two-sided base piece. Likewise, the side panels are paired up in twos, with the decorative sides facing outward; this results in eight two-sided panels. (The resulting pairs may be lightly glued together to facilitate the next step.) The paired side panels are now stitched onto the base (FIG. 3) using decorative cord or wool, lining up the base of the trapezoid that matches the side of the octagon. Next, the side panels are stitched together, resulting in the sides sloping upward (FIG. 4). Finally, the top of the basket is stitched around.

While the kit described above provides for a basket with an octagonal base, the invention is not so limited. Similar kits could vary the shape of the final basket by using any regular polygon pattern as the base. For example, the basket could be made with a hexagonal base with six panels sloping upward. In addition, the side panel can be modified by varying the appearance of the edge of the trapezoid that winds up on top of the basket. For example, the top of the trapezoid can be scalloped (FIG. 5), pointed, or arched.

A greeting card/photo memento basket kit may be comprised of instructions and necessary patterns—for example, one octagonal base pattern and one trapezoid-shaped side pattern. Alternately, the kit could comprise of instructions, patterns, hole puncher, glue stick, large-eyed needle, and lacing material. Or, the components of the kits could be placed in a display and sold separately comprising:

(a) patterns for the base and sides of basket and instructions

(b) various colors and types of lacing material

(c) hole puncher in choice of sizes (approximately ⅛″ or 1/16″)

(d) wide-eyed needle

(e) glue stick

This last embodiment allows for more individualization of the project. The chosen base may be square, hexagonal, octagonal, or decagonal. The top of the sides may be straight, arched, scalloped or pointed. In addition, the lacing material can vary in color and type.

The photo/greeting card memento basket provides a decorative manner of saving and displaying photos and greeting cards. Baskets can be remembrances of birthdays, holidays, graduations, or other special events.

It is intended that all matter contained in the above description and depicted in the accompanying drawings be construed in an illustrative and not in a limiting sense.

The invention claimed is:

1. A kit allowing for the creation of a basket constructed out of photos and/or greeting cards comprising:
(a) an octagonal pattern with hole markings for the base of the basket;
(b) a trapezoidal pattern with hole markings for the sides of the basket; and,
(c) instructions for construction of a basket using these patterns together with photos and/or greeting cards
Whereby said kit enables the construction of a basket out of photos or greeting cards.

2. A kit for making a basket as in claim 1 comprising of patterns which may be tailored to different abilities by modifying the hole markings on the octagonal and trapezoidal patterns, resulting in smaller, more closely spaced holes for the more adept basket maker, or larger, more widely spaced holes, for younger children or for those who are less adept.

3. A kit for making basket as in claim 1 wherein the shape of the base pattern may be square, hexagonal, or decagonal.

4. A kit for making basket as in claim 1 wherein the trapezoidal pattern may be modified so that the base of the trapezoidal piece that will become the top of the basket can be arched, pointed, or scalloped.

5. A kit for making basket as claimed in claim 1 wherein the patterns are made of cardboard.

6. A kit for making basket as claimed in claim 1 wherein the patterns are made of plastic.

7. A kit for making basket as claimed in claim 1 wherein said kit may also contain a hole puncher, lacing thread, and a large-eyed needle.

8. A kit allowing for the creation of a basket constructed out of photos and/or greeting cards whose components are placed in a display and sold separately comprising:
(a) patterns for the base and sides of basket and instructions
(b) various colors and types of lacing material
(c) hole puncher in choice of sizes
(d) wide-eyed needle
Whereby said kit enables the construction of a basket out of photos or greeting cards
